(19) United States
(12) Patent Application Publication
(10) Pub. No.: US 2017/0050227 A1
(43) Pub. Date: Feb. 23, 2017

(54) HOLDING TOGETHER AND TRANSPORTING A METAL BAND ROLLED UP INTO A COIL

(71) Applicant: Primetals Technologies Austria GmbH, Linz (AT)

(72) Inventors: Franz BRATERSCHOFSKY, Goldwoerth (AT); Roland HOFER, Reichenau im Muehlkreis (AT); Harald KAPL, Leonding (AT); Reinhard KARL, Klosterneuburg (AT); Konrad KRIMPELSTAETTER, Katsdorf (AT); Lukas PICHLER, Linz (AT); Jurij RAZINKOV, Linz (AT); Christoph SALZMANN, Linz (AT); Juergen SCHIEFER, Allhaming (AT); Marco STRAUCH, Linz (AT)

(21) Appl. No.: 15/308,004

(22) PCT Filed: Apr. 16, 2015
(86) PCT No.: PCT/EP2015/058246

§ 371 Date: Oct. 31, 2016

(30) Foreign Application Priority Data
May 12, 2014 (EP) 14167893.8

(51) Int. Cl. B21C 47/24; B65G 19/02

(52) U.S. Cl. CPC B21C 47/24; B65G 19/02; B65G 2201/0232

(57) ABSTRACT

A device (1) and a method for holding together and transporting a metal band rolled into a coil (3) after the band is rolled in a coiling station (5). The device (1) includes a removal trolley (20) for receiving the coil (3) in the coiling station (5) and for transporting the coil (3) from the coiling station (5). A coil safety device places a securing sling (40) around the coil (3) fixed on at least part of the circumference, such that the coil (3) is held together by the securing sling (40) and is pressed onto the removal trolley (20).

### CROSS-REFERENCE TO RELATED APPLICATIONS

The present application is a 35 U.S.C. §§371 national phase conversion of PCT/EP2015/058246, filed Apr. 16, 2015, which claims priority of European Patent Application No. 14167893.8, filed May 12, 2014, the contents of which are incorporated by reference herein. The PCT International Application was published in the English language.

### TECHNICAL FIELD

The invention relates to a device and to a method for holding together and transporting a metal strip wound up to form a coil post winding up of said metal strip in a coiling station.

### TECHNICAL BACKGROUND

Pre-rolled metal strips are often wound up to form a so-called coil in hot coiling units. Metal strips of high-tensile grades are in increasing demand and are being produced. If the dead weight of a thick, high-tensile, wound metal strip is no longer sufficient for the wound strip to be stabilized, spontaneous uncoiling of the coil may occur. The internal stresses are relaxed, and the coil increases in diameter. This type of coil poses risks in production and transportation, and the coil requires specialized handling.

DE 10 2011 080 410 A1 discloses a device and a method for handling a metal strip, comprising a coiling installation having a coiling mandrel for winding up of the metal strip to form a coil on the coiling mandrel, and a coil-removal trolley having bearing points for receiving the coil from the coiling mandrel and for them moving the coil out of the coiling installation. To additionally secure the metal strip in the coiling installation when it is being transferred from the coiling mandrel to the coil-removal trolley and during transportation of the coil by the coil-removal trolley, a down-holding arm exerts a down-holding-force on the external circumference of the coil to press the coil onto the bearing points of the coil-removal trolley.

### SUMMARY OF THE INVENTION

It is an object of the invention to provide an improved device and method for holding together and transporting a metal strip wound in a coil after winding up the metal strip in a coiling station.

A device according to the invention for achieving that aspect comprises a coil-removal trolley for receiving the coil in the coiling station and for transporting the coil out of the coiling station. The device further comprises a coil-securing device configured for firmly placing a securing sling around part of the circumference of the coil, such that the coil is held together by the securing sling and is pressed onto the coil-removal trolley.

The invention thus holds a coil together and presses it onto a coil-removal trolley by a securing sling that surrounds the coil on part of its circumference. The securing sling enables a friction-increasing form-fit of the circumferential wrapping of the coil, and an optimized force-fit between the coil, the securing sling, and the coil-removal trolley. This provides a compact construction of the coil-securing device. Comparing the device hereof to prior art securing devices, for example, from DE 10 2011 080 410 A1, for using the invention securing the coil, no complex massive down-holding arm for exerting a down-holding-force on the external circumference of the coil may be used or is required when tying the coil, for example. On account of this, this avoids limitations relating to the coil diameter, which result from the use of a down-holding arm, since the securing sling is configured substantially narrower than a massive down-holding arm. Furthermore, no complex transfer system for transferring the coil prior to and after transportation of the coil is required.

An embodiment of the invention provides the coil-removal trolley with at least one anchor point for a sling end of the securing sling. The flow of force for securing the coil is thereby advantageously directed onto the coil-removal trolley, so that no further component is required to absorb this flow of force.

An embodiment of the invention provides the coil-removal trolley with at least one tensioning device for the securing sling. The securing sling is advantageously integrated in the coil-removal trolley, and the force for tensioning the securing sling is also absorbed by the coil-removal trolley.

A tensioning device preferably has a hydraulic cylinder or a winch, by which a sling end of the securing sling is movable for tensioning the securing sling. On account of high forces required, a hydraulic cylinder and a winch are particularly suitable.

A further embodiment of the invention provides the coil-securing device with a guide frame for the securing sling for advantageously enabling simple positioning and handling of the securing sling.

A refinement of the aforementioned embodiment provides at least one coupling unit for releasably coupling the guide frame to the coil-removal trolley. That coupling avoids a requirement for synchronizing the movements of the guide frame and of the coil-removal trolley where the coil is transported. Releasability of the coupling enables the guide frame to be uncoupled from the coil-removal trolley such that prior to and after transportation of the coil, the guide frame and the coil-removal trolley may be suitably positioned in a mutually independent manner.

Furthermore, the guide frame is preferably movable so as to be guided on rails. Rail-based guiding enables simple and precise moving of the guide frame.

Preferably, the securing sling is configured to be under tensile stress, in particular as a steel strip or a chain or a movable mechanism.

In a method according to the invention for holding together and transporting a metal strip wound up to form a coil after winding up the metal strip in a coiling station, the coil is received in the coiling station by a coil-removal trolley and is transported by the coil-removal trolley out of the coiling station.

A securing sling is firmly placed around part of the circumference of the coil so that prior to and during transportation on the coil-removal trolley the coil is held together by the securing sling and is pressed onto the coil-removal trolley. This method enables a coil to be secured by the securing sling, having the advantages mentioned above.

Corresponding to the above described embodiments of the device, in the method, at least one sling end of the securing sling is also anchored on the coil-removal trolley, and/or the securing sling for holding together the coil and for pressing the coil onto the coil-removal trolley is tensioned by at least one tensioning device which is disposed on the coil-removal trolley, and/or the securing sling is guided in a guide frame, wherein preferably during transportation of the coil on the coil-removal trolley, the guide frame is coupled to the coil-removal trolley and is jointly moved with the coil-removal trolley.

Furthermore, the coil is transported by the coil-removal trolley from the coiling station preferably to a tying station in which tying bands for holding the coil together are placed around the coil.

Securing a coil by a securing sling is advantageous in particular for tying the coil, since the securing sling occupies little space on the circumference of the coil, and in particular less space than a down-holding arm, thus facilitating and simplifying tying of the coil.

A minimum number of tying bands are preferably predefined. The securing sling is released from the coil in the tying station after the minimum number of tying bands has been placed around the coil.

This advantageously enables the securing sling to be released after the coil has been secured against uncoiling by a suitable selected minimum number of tying bands.

The above-described properties, features, and advantages of this invention, and the manner in which the former are achieved, will become more readily and more obviously understandable in the context of the following description of exemplary embodiments which are explained with reference to the drawings in which:

### BRIEF DESCRIPTION OF THE DRAWINGS

FIG. 1 shows a side view of a metal strip, which has been wound up on a coiling mandrel to form a coil, and of a device for holding together and transporting the coil, including a coil-removal trolley and a guide frame, shown uncoupled from the coil-removal trolley, and a securing sling;

FIG. 2 shows a perspective side view of a securing sling in a guide frame and guide-frame rails for the guide frame;

FIG. 3 shows a perspective front view of a guide frame for a securing sling;

FIG. 4 shows the side view FIG. 1 in a different condition;

FIG. 5 shows a releasable coupling of a guide frame to a coil-removal trolley;

FIG. 6 shows a front view of a device for holding together and transporting a coil, having a coil-removal trolley and a guide frame, coupled to the coil-removal trolley, and a securing sling placed around the coil;

FIG. 7 shows a perspective illustration of a coil, of a securing sling placed around the coil, and of a guide frame of the securing sling;

FIG. 8 shows a fixing unit for releasably fixing a sling end of a securing sling to a guide frame or to a tensioning device; and

FIG. 9 shows a side view as in FIG. 1 of a coiling mandrel and of a device for holding together and transporting the coil, having a coil-removal trolley and a guide frame, coupled to the coil-removal trolley, of a securing sling, wherein the device is moved into a tying station by the coiling mandrel.

Equivalent parts are provided with the same reference sign in all Figures.

### DESCRIPTION OF EMBODIMENTS

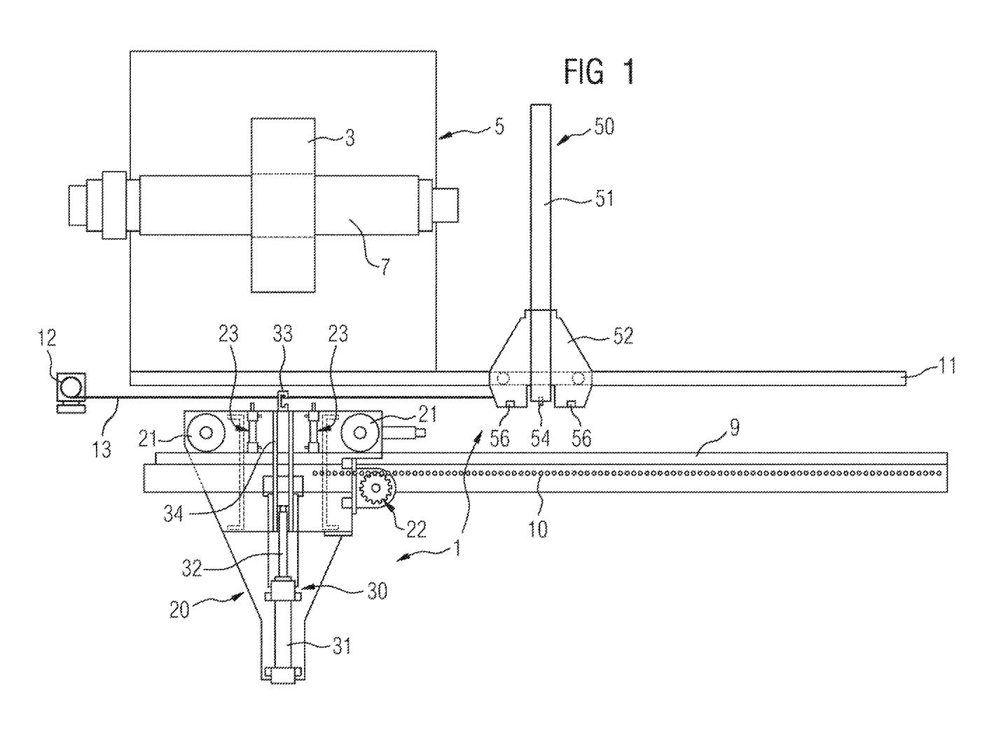

FIG. 1 in a side view showing a device 1 for holding together and transporting a metal strip wound up to form a coil 3, after winding up the metal strip in a coiling station 5. The metal strip is wound around a coiling mandrel 7 of the coiling station 5 (not otherwise illustrated in more detail).

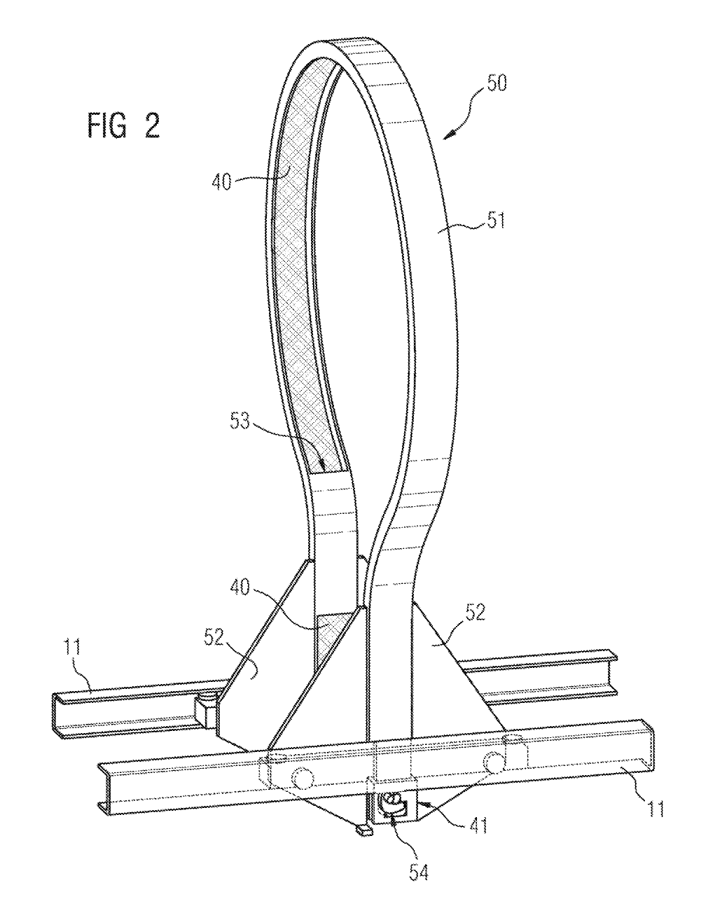

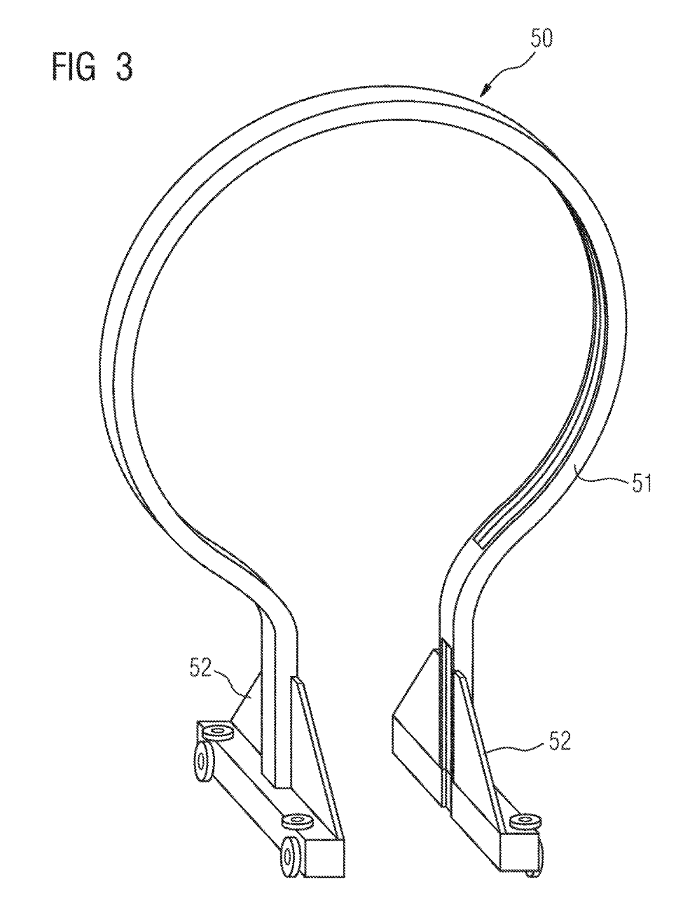

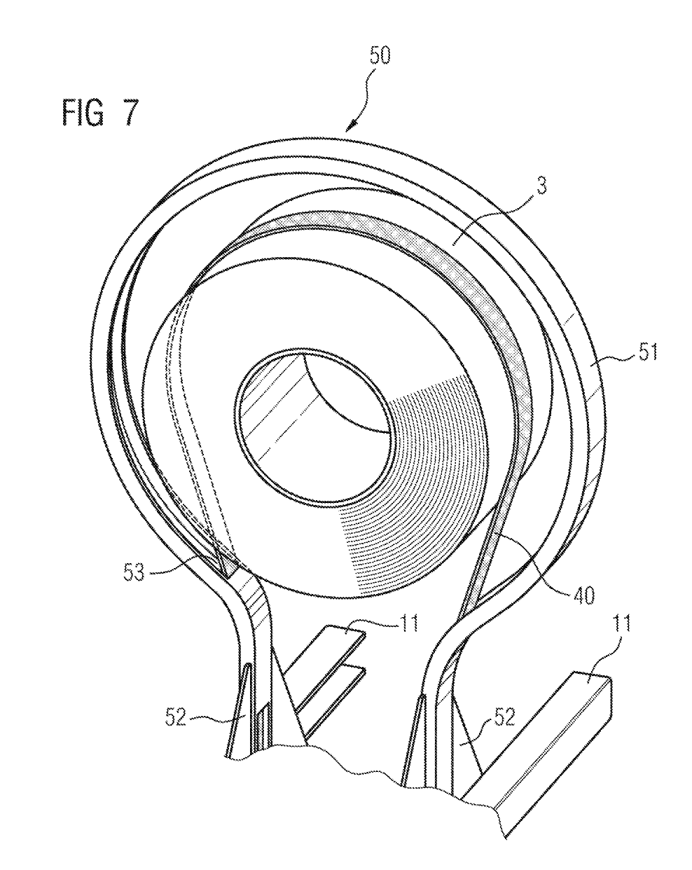

The device 1 comprises a coil-removal trolley 20 for receiving the coil 3 in the coiling station 5 and for transporting the coil 3 out of the coiling station 5, and a coil-securing device which is configured for firmly placing a securing sling 40 (not visible in FIG. 1, but in FIGS. 2 and 7) around part of the circumference of the coil 3, such that prior to and during transportation on the coil-removal trolley 20, the coil 3 is held together by the securing sling 40 and is also pressed onto the coil-removal trolley 20. The securing sling 40 is guided in a guide frame 50 (seen in FIGS. 2 and 3).

The coil-removal trolley 20 has coil-removal trolley wheels 21 enabling the trolley to move on coil-removal trolley rails 9, for example, by means of a hydraulic rack drive 22 along a rack 10.

A guide frame 50 is movable on guide-frame rails 11 which extend parallel with the coil-removal trolley rails 9. For example, the frame 50 is moved by a rope winch 12 drawing a tackle 13.

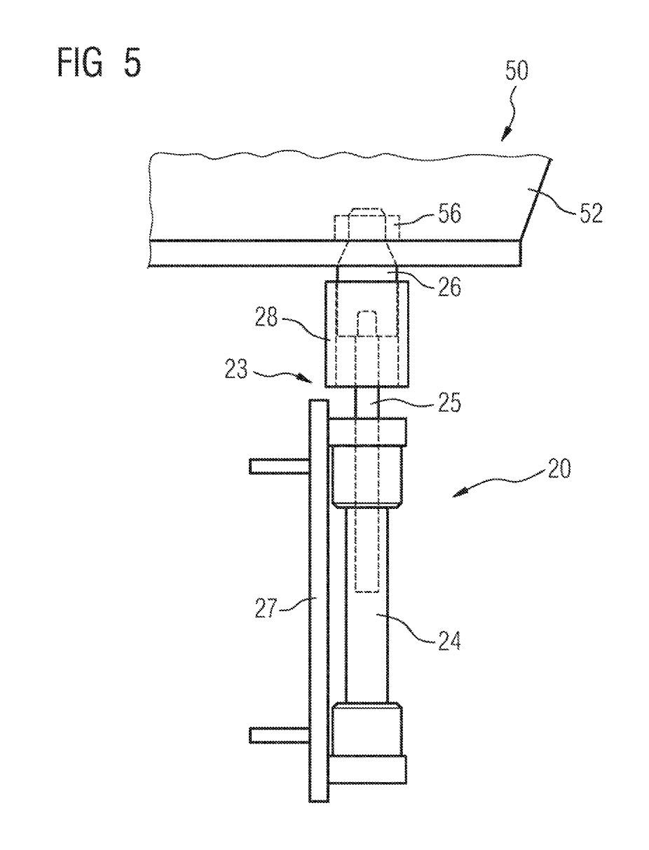

Two coupling units 23 releasably couple the guide frame 50 to the coil-removal trolley 20. A tensioning device 30 tensions the securing sling 40, and the coupling units 23 will be described in more detail with reference to FIGS. 1 and 5. The tensioning device 30 comprises a first hydraulic drive having a first hydraulic cylinder 31, and a first piston 32 which is guided in the first hydraulic cylinder 31, a hook element 33, and a connection rod 34 which connects the first piston 32 to the hook element 33. As shown in FIGS. 1, 2, and 5 and described below, a sling end 41 of the securing sling 40 may be anchored to the hook element 33 on the coil-removal trolley 20, and by means of the first hydraulic cylinder 31 thereafter be pulled downward in order for the securing sling 40 to be tensioned.

The coil-removal trolley 20 and the guide frame 50 are located in their respective initial positions in FIG. 1. The coil-removal trolley 20 is located below the coil 3. The guide frame 50 is located in front of the coiling mandrel 7.

FIG. 2 shows a perspective side view of a securing sling 40 in a guide frame 50, and of guide-frame rails 11 for the guide frame 50. FIG. 3 shows a perspective front view of a guide frame 50.

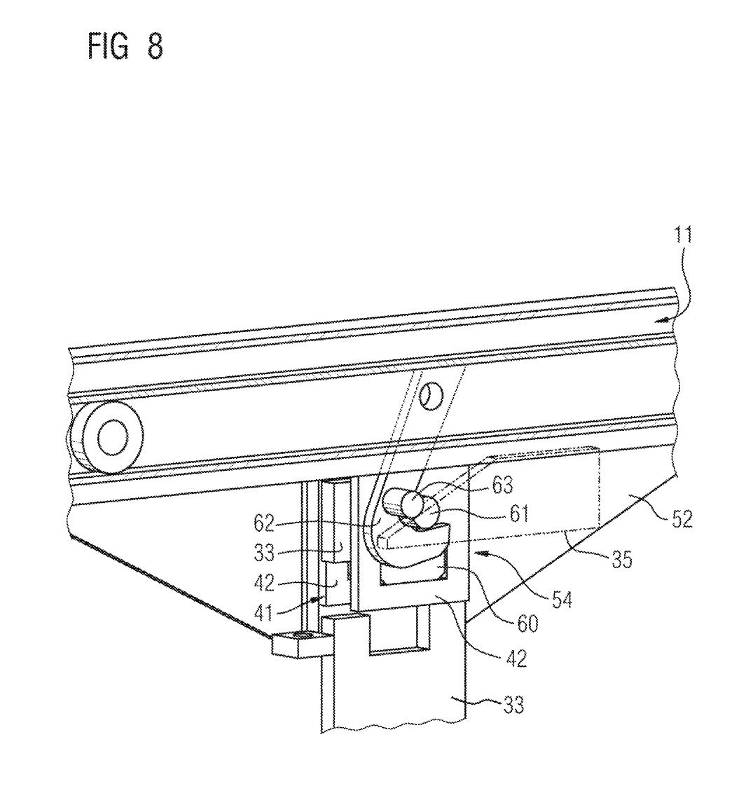

An upper part of the guide frame 50 has the shape of an open annular guide 51. The lower part of the guide frame 50 is formed by two base portions 52, each adjoining one end of the annular guide 51 and each being guided in a respective guide-frame rail 11. In the region of the annular guide 51, the securing sling 40 is guided on the inboard side of the annular guide 51. In the transition regions between the annular guide 51 and the two base portions 52, the securing sling 40 is in each case guided through a guide duct 53 in the guide frame 50. In the region of each base portion 52, the securing sling 40 is guided from an exit of a guide duct 53 to a fixing unit 54, explained with FIG. 8 and which reasonably fixes a sling end 41 of the securing sling 40 to the respective base portion 52.

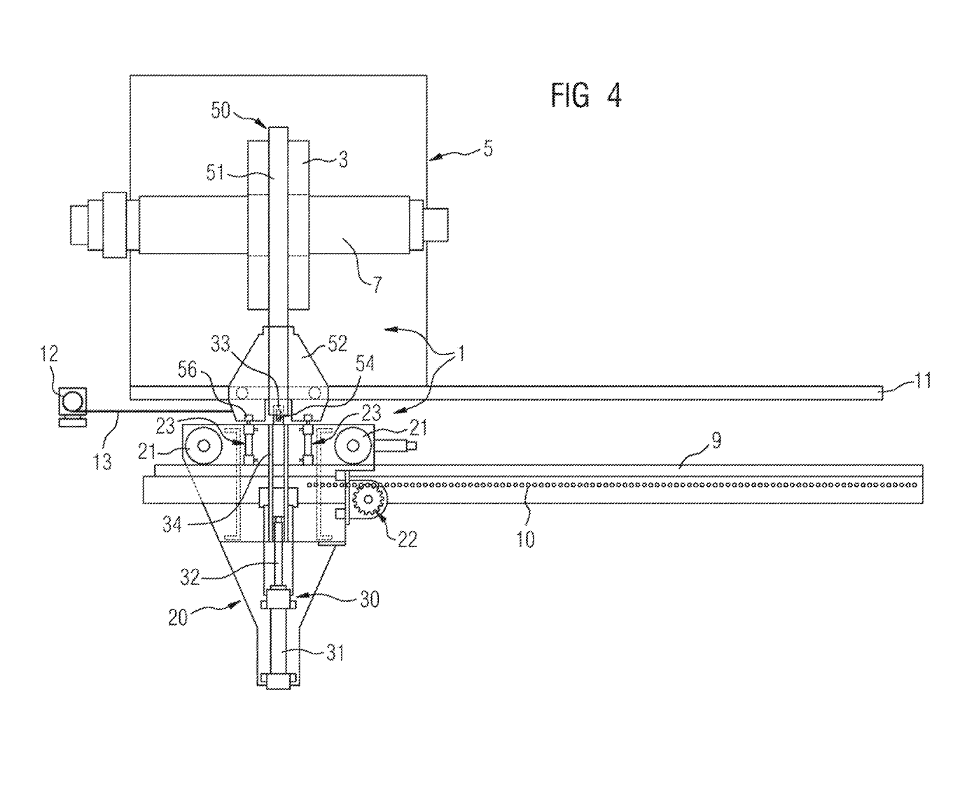

FIG. 4 in a side view shows the coil-removal trolley 20 and the guide frame 50 in positions for transferring the coil 3 from the coiling mandrel 7 to the coil-removal trolley 20. The coil-removal trolley 20 is still in the initial position thereof as shown in FIG. 1, below the coil 3. The guide frame 50 has moved from the initial position thereof in FIG. 1 toward the coil-removal trolley 20 where the annular guide 51 passes around the coil 3. Furthermore, the guide frame 50 is coupled to the coil-removal trolley 20 by the coupling units 23, as described by means of FIG. 5.

FIG. 5 shows coupling of the guide frame 50 to the coil-removal trolley 20 by a coupling unit 23. The coupling unit 23 comprises a second hydraulic cylinder 24, a second piston 25 which is guided in the second hydraulic cylinder 24, and a bolt element 26 connected to the second piston 25. The second hydraulic cylinder 24 is fastened to the coil-removal trolley 20 by a mount 27. To couple the guide frame 50 to the coil-removal trolley 20, by means of the second hydraulic cylinder 24 and of the second piston 25, the bolt element 26 is driven into a bolt receptacle 56, corresponding to the bolt element 26, in the guide frame 50. The bolt element 26 is guided in a bolt guide 28. Preferably, there are a plurality of coupling units 23 of this type, for example four, and corresponding bolt receptacles 56.

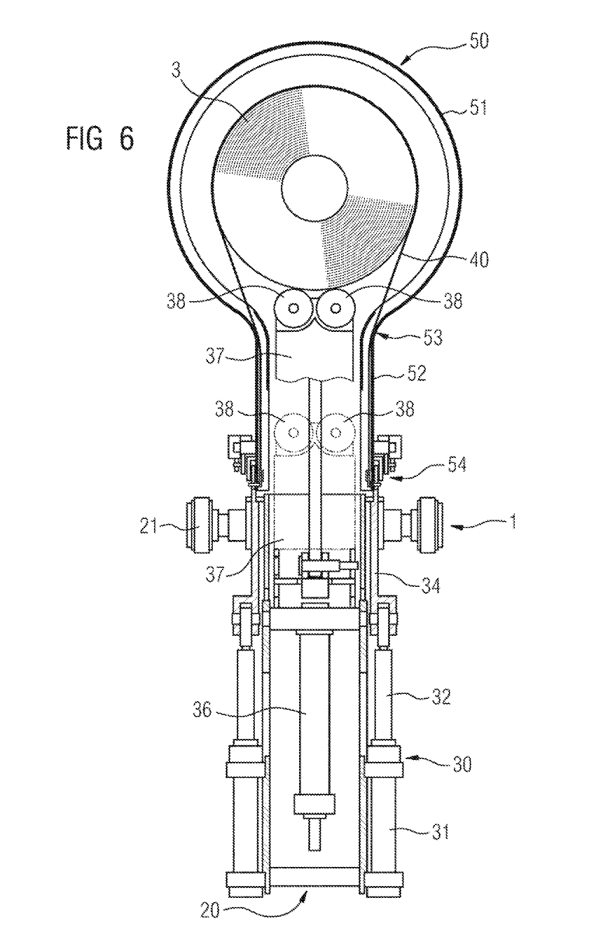

FIG. 6 shows the device 1 for holding together and transporting the coil 3 in a front view, after the securing sling 40 has been firmly placed around the coil 3. Before the securing sling 40 is tensioned, a movable mounting cylinder 37 of the coil-removal trolley 20, and mounting rollers 38 which are disposed on the mounting cylinder 37, are first moved close to the coil 3 by a third hydraulic cylinder 36 of the coil-removal trolley 20, causing the mounting rollers 38 to bear on the circumference of the coil 3, and pressing the coil 3 against the coiling mandrel 7. Thereafter, the securing sling 40 is tensioned by two tensioning devices 30 so that each of the sling ends 41 of the securing sling 40 is pulled downward by means of the first hydraulic cylinder 31 of a tensioning device 30 (FIG. 8). By tensioning the securing sling 40, the coil 3 is held together and is pressed onto the mounting rollers 38.

After the securing sling 40 has been tensioned, the coiling mandrel 7 is contracted to reduce its diameter, and by means of the device 1 in the state as shown in FIG. 6, the coil 3 is pulled off the coiling mandrel 7 and transported out of the coiling station 5.

FIG. 7 is a perspective illustration shows the coil 3 and the securing sling 40, tensioned around the coil 3, in the guide frame 50.

FIG. 8 shows a fixing unit 54 releasably fixing a sling end 41 of the securing sling 40 to a base portion 52 of the guide frame or of a tensioning device 30 of the coil-removal trolley 20. The sling end 41 has two mutually parallel end pieces 42, each having one bore. A connection bolt 60 which interconnects the end pieces 42 and which has a retaining mandrel 61 which projects toward the outer side of the base portion 52 is guided through the bores. The fixing unit 54 furthermore has a hook-shaped lever element 62 which is pivotably mounted on the base portion 52 and which in the position illustrated in FIG. 8 retains the retaining mandrel 61 such that the sling end 41 is fixed to the base portion 52 of the guide frame 50. The lever element 62 has an activation mandrel 63 which projects toward the outer side of the base portion 52 and which interacts with a wedge 35 which is disposed on the guide-frame rails 11. When the guide frame 50 is slid over the coil-removal trolley 20, the connection bolt 60 is guided into the hook element 33 of a tensioning device 30 of the coil-removal trolley 20, the wedge sliding below the activation mandrel 63 and pushing the latter upward such that the lever element 62 is pivoted away from the retaining mandrel 61 of the connection bolt 60, releasing the retaining mandrel 61. On account of the foregoing, the sling end 41 is released from the guide frame 50 and coupled to the hook element 33 such that the sling end 41 may be moved by the tensioning device 30 with which the hook element 33 is associated, so as to tension the securing sling 40. Preferably, each of the two sling ends 41 of the securing sling 40 is capable in this manner of being simultaneously coupled to one tensioning device 30 of the coil-removal trolley such that the securing sling 40 may be tensioned by simultaneously pulling the two sling ends 41.

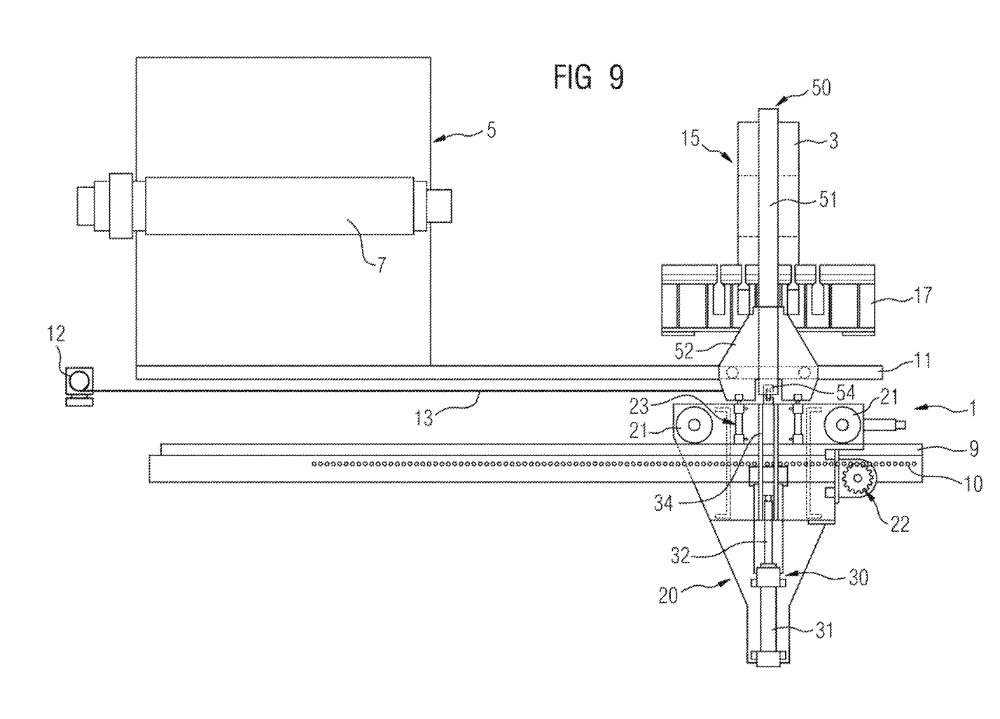

FIG. 9 shows the device 1 in its terminal position, after the coil 3 has been transported from the coiling station 5 to a tying station 15. A tying device 17 places tying bands for holding together the coil 3 around the coil 3 in the tying station 15. To this end, a minimum number of tying bands is pre-defined, and the securing sling 40 is released from the coil 3 in the tying station, once the minimum number of tying bands has been placed around the coil 3.

Subsequently, the guide frame 50 and the coil-removal trolley 20 are mutually uncoupled and moved to the initial positions as shown in FIG. 1.

While the invention has been illustrated and described in more detail by way of preferred exemplary embodiments, the invention is not limited by the examples disclosed, and other variations may be derived therefrom by a person skilled in the art without departing from the scope of protection of the invention.

### LIST OF REFERENCE SIGNS

1 Device for holding together and transporting a coil

3 Coil

5 Coiling station

7 Coiling mandrel

9 Coil-removal trolley rail

10 Rack

11 Guide frame rail

12 Rope winch

13 Tackle

15 Tying station

17 Tying device

20 Coil-removal trolley

21 Coil-removal trolley wheel

22 Rack drive

23 Coupling unit

24 Second hydraulic cylinder

25 Second piston

26 Bolt element

27 Mount

28 Bolt guide

30 Tensioning device

31 First hydraulic cylinder

32 First piston

33 Hook element

34 Connection rod

35 Wedge

36 Third hydraulic cylinder

37 Mounting cylinder

38 Mounting roller

40 Securing sling

41 Sling end

42 End piece

50 Guide frame

51 Annular guide

52 Base portion

53 Guide duct

54 Fixing unit

56 Bolt receptacle

60 Connection bolt

61 Retaining mandrel

62 Lever element

63 Activation mandrel

1. A device for holding together and transporting a metal strip wound up to form a coil after winding up the metal strip in a coiling station, the device comprising:
a coil-removal trolley configured for receiving the coil in the coiling station and for transporting the coil out of the coiling station;
a securing sling for securing the coil;
and a coil-securing device configured for firmly placing the securing sling around at least a part of a circumference of the coil such that the coil is held together by the securing sling and/or the sling is configured to press the coil onto the coil-removal trolley.

2. The device as claimed in claim 1, further comprising at least one anchor point, on the coil-removing trolley for anchoring a sling end of the securing sling.

3. The device as claimed in claim 2, further comprising at least one tensioning device at the coil-removal trolley connected to the sling for tensioning the securing sling.

4. The device as claimed in claim 3, further comprising the tensioning device having a hydraulic cylinder or a winch, connected to and configured for moving a sling end of the securing sling for tensioning the securing sling.

5. The device as claimed in claim 1, further comprising the coil-securing device has a guide frame configured for guiding the securing sling in the frame.

6. The device as claimed in claim 5, further comprising
at least one coupling unit for releasably coupling the guide frame to the coil-removal trolley and for holding the sling at the trolley.

7. The device as claimed in claim 5, further comprising the guide frame is movable and guide rails on which the guide frame is guided toward or away from the trolley.

8. The device as claimed in claim 1, further comprising the securing sling is configured as a steel strip, or as a chain, or as a movable mechanism or as a device under tensile stress.

9. A method for holding together and transporting a metal strip wound up to form a coil after winding up the metal strip in a coiling station, the method comprising:
receiving the coil in a coiling station by using a coil-removal trolley and transporting the coil by means of the coil-removal trolley out of the coiling station; and
placing a securing sling firmly around at least part of a circumference of the wound coil prior to and during transportation of the coil on the coil-removal trolley such that the coil is held wound and together by the securing sling and the sling presses the coil onto the coil-removal trolley.

10. The method as claimed in claim 9, wherein the sling has ends by which the sling is held to the trolley, the method comprising:
at least one of the sling ends of the securing sling is anchored on the coil-removal trolley.

11. The method as claimed in claim 9, further comprising tensioning the securing sling on the coil for holding the coil together and for pressing the coil onto the coil-removal trolley, wherein the tensioning is by at least one tensioning device disposed on the coil-removal trolley.

12. The method as claimed in claim 9, further comprising guiding the securing sling in a guide frame.

13. The method as claimed in claim 12, further comprising during transportation of the coil on the coil-removal trolley, the guide frame coupling between ends of the sling to the coil-removal trolley and jointly moving the guide frame along with the coil-removal trolley.

14. The method as claimed claim 9, further comprising transporting the coil by the coil-removal trolley from the coiling station to a tying station; and
placing tying bands around the coil for holding together the coil at the tying station.

15. The method as claimed in claim 14, further comprising predefining a minimum number of tying bands, and releasing the securing sling from the coil in the tying station once the minimum number of tying bands has been placed around the coil.

16. The device as claimed in claim 3, further comprising:
an element for being pressed against the wound coil between ends of the sling and in a direction to oppose the direction in which the sling urges the coil for aiding retention of the coil in a wound state.

17. The method as claimed in claim 11, further comprising pressing against the wound coil between ends of the sling in a direction to oppose the direction in which the sling urges the coil for aiding retention of the coil in a wound state.

18. The device as claimed in claim 1, further comprising at least one tensioning device at the coil-removal trolley connected to the sling for tensioning the securing sling.
